(19) United States
(12) Patent Application Publication
(10) Pub. No.: US 2012/0234862 A1
(43) Pub. Date: Sep. 20, 2012

(54) Fluid Dispenser with Increased Stability

(76) Inventor: Hardave S. Kharbanda, San Antonio, TX (US)

(21) Appl. No.: 13/420,447

(22) Filed: Mar. 14, 2012

Related U.S. Application Data
(60) Provisional application No. 61/465,093, filed on Mar. 14, 2011.

(51) Int. Cl. B67D 7/84; G01F 11/00

(52) U.S. Cl. 222/173; 222/321.9

(57) ABSTRACT

A dispenser with increased stability includes a pillar tube extending from the stem-spring chamber assembly at the top of the fluid reservoir to the bottom of the fluid reservoir. The pillar tube transmits the force from the hand of the user used to dispense fluid to a pressure sensitive attachment device on the bottom of the fluid reservoir.

### CROSS REFERENCE TO RELATED APPLICATION

This application claims the benefit of Provisional U.S. Patent Application No. 61/465,093 filed Mar. 14, 2011.

### STATEMENT REGARDING FEDERALLY FUNDED RESEARCH AND DEVELOPMENT

The invention described in this patent application was not the subject of federally sponsored research or development.

### FIELD

The present invention pertains to fluid dispensers; more particularly, the present invention pertains to a fluid dispenser of the type typically located on the edge of a sink for providing a user with small amounts of liquid soap, liquids, lotions, as well as an atomized or mist spray.

### BACKGROUND

The numerous parts included in the top portion of a dispenser of the type typically found on the edge of a sink create its high center of gravity and thus its instability. This instability is the source of the inconvenience which results from the pump dispenser being either tipped over or moving away from the user when the hand of the user is placed thereon.

An analysis of the forces on a dispenser reveals that the action of placing manual force on the top of a dispenser to dispense a small amount of fluid will cause the dispenser to tip over or to move along the surface on which the dispenser rests, unless the user happens to be exerting a force which is directly along the vertical axis of the dispenser and vertically above the center of gravity of the dispenser.

Those dispensers which are close to being empty are less stable and more prone to being tipped over and moving when the force from a user's hand is exerted thereon.

Some dispensers are relatively tall compared to the diameter of their bottom surface. Such dispensers also tend to tip over when the force of a user's hand is exerted thereon to dispense a small amount of fluid.

While liquid is contained in the dispenser, it is not unusual for a small amount of dispensed liquid to either seep underneath or flow around the bottom surface of the dispenser. This small amount of dispensed liquid will make the surface upon which the dispenser rests slippery. The resulting effect is that the frictional forces which prevent the dispenser from moving across the surface on which it rests are reduced.

Several attempts to prevent dispensers from tipping over or sliding over the surface on which the dispenser rests have been made. These attempts include shaping a dispenser to have a relatively large bottom surface; constructing the bottom portion of the dispenser from a relatively heavy material; making the entire dispenser from a relatively heavy material; placing the dispenser within a stable basket or wire frame; or, some combination of the foregoing. These attempts to solve the problem of instability of a dispenser generally prevent the dispenser from tipping over or prevent the dispenser from moving over the surface on which it rests by causing the dispenser to have a lower center of gravity and greater total mass.

Another common way of keeping a dispenser, particularly a pump dispenser for liquid soap, from tipping over or moving over the surface on which the dispenser rests has been to attach a suction cup to the bottom surface of the dispenser. However, after an individual has endeavored to create a suction connection of the suction cup to the surface on which the pump dispenser rests through the application of firm downward force on the main pump dispenser structure, it takes only a short period of time for air to seep underneath the suction cup thereby causing the suction connection of the suction cup to the surface on which it rests to first weaken, then be lost entirely.

The period of time between uses of a pump dispenser having a suction cup thereon is typically long enough to cause the suction connection associated with the previous use of the pump dispenser to weaken or even be lost. Once the suction connection is weakened or lost, the user must begin the subsequent uses of the dispenser by re-establishing the suction connection.

Users of dispensers typically do not check or re-establish the suction connection at the bottom of a dispenser prior to every use of the dispenser. This leads to a conclusion by the user of the dispenser that the suction connection is ineffective and that attempting to re-establish the suction connection will obtain ineffective results.

The first downward stroke in the use of a dispenser after the suction connection has been weakened or lost does not reliably transmit force to the top of the suction cup on the bottom of the dispenser in a way that strongly and immediately re-establishes a suction connection, for the reasons explained below.

It has been found that after the suction connection from the prior use of the dispenser has been either weakened or lost, the first downward stroke in a subsequent use of the dispenser has the potential to cause the dispenser to tip over or move the dispenser over the surface on which it rests even when a suction cup is attached to the bottom of the dispenser.

U.S. Pat. No. 2,736,468 to Hills, entitled “Liquid Soap Dispenser”, describes a convenient way of applying force to the top of a suction cup attached to a dispenser to re-establish a suction connection. In this reference, the pump dispenser is shown as being attached to a vertical surface. Therefore, the suction cup is attached to the side of the pump dispenser. To put force on the suction cup to establish a suction connection, the user presses on the side surface of the pump dispenser at a location which is opposite to the attachment point of the suction cup. Two inward, beam-like projections are affixed to the inner surface of the pump dispenser, at the locations where the user exerts force to dispense fluid and at the location where the suction cup is attached to the pump dispenser. When the user presses on the side surface of the pump dispenser, the projection located where the user exerts force comes into contact with the projection located at the suction cup. The suction cup is therefore depressed and the suction connection of the pump dispenser to the vertical surface is re-established.

Although the invention in U.S. Pat. No. 2,736,468 provides an easier way of re-establishing a suction connection than having to push on the entire reservoir of the fluid contained within the dispenser, it still does not offer a solution to the greater problem of re-establishing a weakened or lost suction connection prior to each use of the dispenser.

Accordingly, the need remains in the art for a fluid dispenser that links the action of dispensing fluid from the dispenser with the re-establishment or reinforcement of the suction connection of a dispenser to the surface on which the dispenser rests.

### SUMMARY

The disclosed invention provides a construction for a dispenser which links the action of dispensing fluid from a dispenser with the re-establishment or reinforcement of the suction connection of the dispenser to the surface on which it rests.

The disclosed construction for a dispenser involves the placement of a force sensitive attachment device, such as a suction cup, on the bottom of a dispenser, enabling a direct transmission of part of the force applied by a user for the dispensing of fluid to the top of the suction cup on the bottom of the dispenser. The result is that the suction connection of the dispenser to the surface on which it rests is quickly re-established or reinforced when the user applies the first push to dispense fluid from the dispenser.

The disclosed construction of a dispenser includes a spring chamber assembly at the top. The spring chamber assembly receives force from the hand of the user and enables a small quantity of fluid from within the fluid reservoir to be dispensed. Extending downwardly from the spring chamber through the fluid reservoir is an internal pillar tube. It is the internal pillar tube within the fluid reservoir which transmits mechanical force to the suction cup located on the bottom of the dispenser. Thus, the force exerted by the user on the top of the dispenser not only dispenses a small quantity of fluid but also reinforces the suction connection of the suction cup on the bottom of the dispenser to the surface on which it rests.

### BRIEF DESCRIPTION OF THE DRAWING FIGURES

A still better understanding of the fluid dispenser with increased stability may be had by reference to the drawing figures wherein:

FIG. 1 is a front elevational view, in partial section, of an unstable prior art pump dispenser;

FIG. 2 is a front elevational view, in partial section, of the liquid dispenser with increased stability of the present invention;

FIG. 3A is a front elevational view, in partial section, of a first alternate embodiment of the pillar tube;

FIG. 3B is a front elevational view, in partial section, of a second alternate embodiment of the pillar tube;

FIG. 4A is a front elevational view, in partial section, of a first alternate embodiment of the bottom surface of the fluid reservoir and the suction cup;

FIG. 4B is a front elevational view, in partial section, of a second alternate embodiment of the bottom surface of the fluid reservoir and the suction cup;

FIG. 4C is a front elevational view, in partial section, of a third alternate embodiment of the bottom surface of the fluid reservoir and the suction cup;

FIG. 4D is a front elevational view, in partial section, of a fourth alternate embodiment of the bottom surface of the fluid reservoir and the suction cup;

FIG. 5 is a front elevational view, in partial section, of the bottom surface of the fluid reservoir and the suction cup including magnetic pieces;

FIG. 6 is a front elevational view, in partial section, of an aerosol dispenser including the disclosed invention; and

FIG. 7 is a front elevational view, in partial section, of a misting type dispenser including the disclosed invention.

### DESCRIPTION OF THE EMBODIMENTS

There are three types of dispensers that are commonly used. The first is a pump dispenser where the force from the user's hand is used to dispense a small amount of fluid. The second type of dispenser is an aerosol dispenser where pressure from within the fluid reservoir propels fluid out of the dispenser in droplets when a force from the user's hand is placed thereon. The third type of dispenser is a misting type dispenser where several applications of force to a slide pump from the user's hand are required to pressurize the dispenser. The pressure within the dispenser created by the user is used to propel the fluid within the fluid reservoir to be dispensed as a mist.

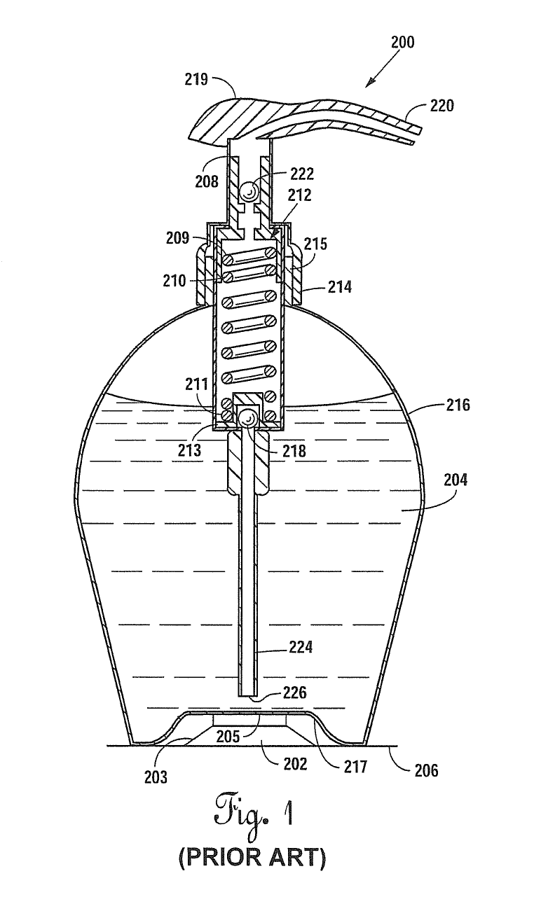

To provide a better understanding of the disclosed invention, the components of the basic construction of a typical prior art pump dispenser 200 having a suction cup on the bottom is shown in FIG. 1. The operation of the prior art pump dispenser 200 shown in FIG. 1 is described below.

A suction cup 202 is shown in FIG. 1. The inclusion of a suction cup makes it easier to explain how the present invention utilizes the force exerted by the hand of the user on the top of the pump dispenser to both dispense fluid and re-establish or reinforce the suction connection of the suction cup 202 on the bottom of the pump dispenser to the surface 206 on which it rests.

Those of ordinary skill in the art will understand that the fluid 204 dispensed by a prior art pump dispenser 200 may be a liquid or a flowable semi-solid or a gas. The fluid 204 dispensed from a pump dispenser exits the nozzle 220 as a stream, as foam, as droplets, or as a mist.

The prior art pump dispenser 200 is initially attached to the surface 206 on which it rests by establishing a suction connection. Typically, a user will take a new pump dispenser from its packaging and grab the sides of the fluid reservoir 216. Downward force on the pump dispenser 200 exerts force on the top 205 of the suction cup 202. This force dispels air out from underneath the suction cup 202, thereby creating a volume of relatively low air pressure underneath the suction cup 202. Air at atmospheric pressure above the suction cup 202 pushes downwardly on the suction cup 202 and establishes the suction connection to surface 206 on which the pump dispenser 200 rests. As previously indicated, air will seep under the edge 203 of the suction cup 202. Eventually, the air pressure underneath the suction cup 202 will return to atmospheric pressure. Such return to atmospheric pressure first weakens then causes the suction connection to be lost. For force exerted on the top 205 of the suction cup 202 to more effectively dispel air from underneath the suction cup 202, the pump dispenser 200 must rest on a relatively hard, flat, and immobile surface 206, such as a bathroom sink or a kitchen counter.

To operate the prior art pump dispenser 200 shown in FIG. 1, the user pushes downwardly on a surface at the rear portion 219 of the nozzle 220. This force causes the stem 208 to move downwardly. This downward movement of the stem 208 is transmitted to the top 209 of the spring 210 within the spring chamber assembly 212. Since the spring chamber assembly 212 is firmly affixed to the cap 214 on the neck 215 at the top of the fluid reservoir 216, the bottom 211 of the spring 210 encounters a resistance at the bottom 213 of the spring chamber assembly 212. The result is that the spring 210 within the spring chamber assembly 212 is compressed. The volume within the spring chamber assembly 212 available to contain fluid is reduced. Because of the presence of the lower ball check valve 218, fluid 204 in the spring chamber assembly 212 is expelled upwardly through the upper ball check valve 222 through the stem 208 and then dispensed into the hand of the user through the nozzle 220. When the user releases downward pressure on the stem 208, the stored energy within the spring 210 returns the spring 210 to its un-compressed state, thereby providing the stem 208 with an automatic upstroke. The volume of the spring chamber assembly 212 available to contain fluid 204 returns to its initial volume. Due to the presence of the upper ball check valve 222, the pocket of relatively low air pressure that has transiently formed near the base 207 of the stem 208 ultimately causes fluid within the fluid reservoir 216 to be sucked through the opening 226 at the bottom of the fluid intake tube 224 into the spring chamber assembly 212. The dispenser 200 is now ready for another downstroke to be applied to the stem 208.

The path of transmission of downward force from the user to the top of the suction cup 202 that is associated with operation of the prior art pump dispenser 200 shown in FIG. 1 can be seen to be:
User→stem 208→spring 210 within spring chamber assembly 212→bottom 213 of spring chamber assembly 212→cap 214 of fluid reservoir 216→neck 215 of fluid reservoir 216→side surfaces of fluid reservoir 216→bottom surface 217 of fluid reservoir 216→top 205 of suction cup 202

In a prior art pump dispenser 200, the exertion of pressure on the top 205 of the suction cup 202 is delayed after the application of force from the user's hand. Furthermore, by the time the force from the user's hand reaches the top 205 of the suction cup 202, the pressure exerted on the top 205 of the suction cup 202 has been significantly attenuated with respect to the pressure that would have been exerted on the top 205 of the suction cup 202 had the user somehow applied his or her downward force directly to the top 205 of the suction cup 202. Users of prior art pump dispensers, such as the prior art dispenser 200 described in FIG. 1, will understand that a strong, reliable suction connection to the surface around a sink or on a kitchen counter is difficult to obtain from the action of dispensing fluid from the pump dispenser.

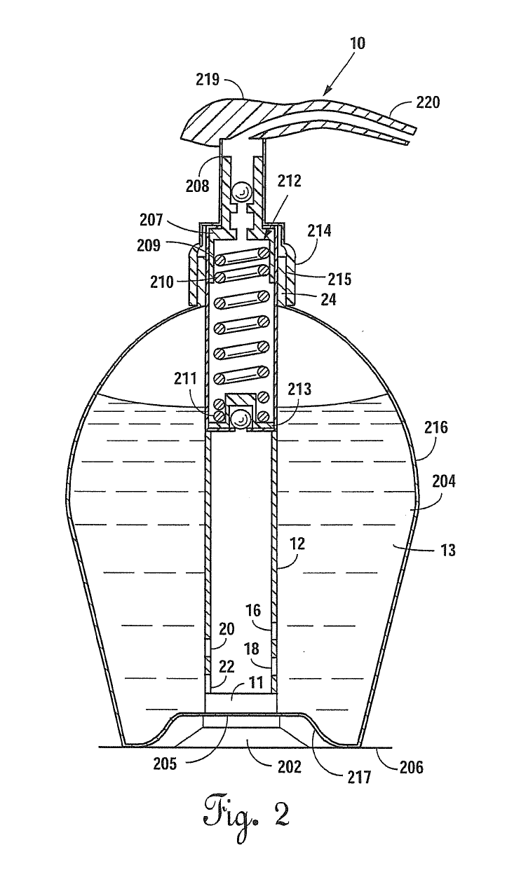

The preferred embodiment 10 of the disclosed invention is illustrated in FIG. 2. All unlabeled components are understood to have the same names and numbers that were shown in FIG. 1.

The operation of the preferred embodiment 10 of the disclosed invention applied to pump dispensers begins the same way as that of the prior art pump dispenser 200 depicted in FIG. 1. Specifically, an individual pushes downwardly on a surface 219 at the rear of the nozzle 220. This downward force goes to the top of the stem 208. The whole stem 208 is moved downwardly. This downward movement of the stem 208 causes the top 209 of the spring 210 within the spring chamber assembly 212 to be pushed downwardly. The bottom 211 of the spring 210 meets resistance at the bottom 213 of the spring chamber assembly 212. However, according to the present invention, this resistance is not a result of the spring chamber assembly 212 being attached to the cap 214 on the neck 215 of the fluid reservoir 216 as shown in FIG. 1.

According to the construction of the pump dispenser 10 of the present invention shown in FIG. 2, the spring chamber assembly 212 has been intentionally detached from the cap 214. The bottom 213 of the spring chamber assembly 212 is resistant to movement because a pillar tube 12 is placed underneath the spring chamber assembly 212. The pillar tube 12 shown in FIG. 2 takes the place of the fluid intake tube 224 used in the prior art fluid dispenser 200 shown in FIG. 1.

The bottom 14 of the pillar tube 12 rests on the inside of the bottom surface 217 of the fluid reservoir 216 prior to dispensing fluid from the pump dispenser 10. The downward movement of the pillar tube 12 is prevented by the bottom surface 217 of the fluid reservoir 216. This resistance to movement caused by the contact between the bottom 14 of the pillar tube 12 with the bottom surface 217 of the fluid reservoir 216 causes the spring 210 within the spring chamber assembly 212 to be compressed.

The remainder of the operation of the pump dispenser 10 depicted in FIG. 2 is just as described with respect to the pump dispenser 200 depicted in FIG. 1, except that the release of stored energy from the spring 210 as it relaxes within the spring chamber assembly 212 is ultimately associated with fluid 204 from the fluid reservoir 216 being sucked into the spring chamber assembly 212 via the pillar tube 12 as opposed to being sucked into the spring chamber assembly 212 through the fluid intake tube 224 in the prior art embodiment 200 shown in FIG. 1. Fluid entry into the pillar tube 12 in FIG. 2 is through one or more holes 16, 18, 20, 22 formed in the wall 13 of the pillar tube 12 as opposed to entering through a single opening 226 at the lower end of fluid intake tube 224 as shown in FIG. 1. The bottom of the pillar tube 12 is closed by the use of a solid disk 11.

The path of transmission of the downward force exerted by the hand of the user to the top 205 of the suction cup 202 that is associated with the operation of the disclosed pump dispenser 10 with increased stability of the current invention can now be seen to be:
User→stem 208→spring 210 within spring chamber assembly 212→bottom 213 of spring chamber assembly 212→pillar tube 12→bottom surface 217 of fluid reservoir 216→top 205 of suction cup 202

According to the disclosed invention 10, the force exerted by the user is transmitted along a straight downward vector to the top 205 of the suction cup 202. This force is delivered from the top of the stem 208 directly to the top 205 of the suction cup 202 by the pillar tube 12. This path for transmission of force to the top 205 of the suction cup 202 minimizes the delay in the exertion of pressure on the top 205 of the suction cup 202 after the application of force from the user's hand to the top of the pump dispenser 10. This path for transmission of force to the top 205 of the suction cup 202 also causes the force exerted on the top 205 of the suction cup 202 to be minimally attenuated with respect to the force that would have been exerted on the top 205 of the suction cup 202 had the user somehow applied force directly to the top 205 of the suction cup 202.

The establishment of a suction connection by the act of starting the dispensing of fluid with the inventive construction of the pump dispenser 10 illustrated in FIG. 2 is faster and stronger than the establishment of a suction connection with the prior art pump dispenser 200 shown in FIG. 1.

The pillar tube 12 as shown in FIG. 2 serves three major functions. First, the pillar tube 12 helps to directly transmit the force applied by the user's hand to dispense fluid to the top 205 of the suction cup 202. This direct transmission of force permits the advantages provided by the present invention to be experienced by the user. Second, the pillar tube 12 draws fluid from the fluid reservoir 216 as the fluid intake tube 224 of a prior art dispenser 200 would normally do. Third, the pillar tube 12 holds the spring chamber assembly 212 in position within the fluid reservoir 216 since the spring chamber assembly 212 is detached from the cap 214 on the neck 215 of the fluid reservoir 216.

A substantially cylindrical ring 24 is shown surrounding and affixed to the outer surface of the spring chamber assembly 212 in FIG. 2. The substantially cylindrical ring 24 shown in FIG. 2 assures that the pillar tube 12 attached to the bottom 213 of the spring chamber assembly 212 will always be oriented in a substantially vertical direction within the fluid reservoir 216. The substantially cylindrical ring 24 illustrated in FIG. 2 prevents the entire stem 208-spring chamber assembly 212-pillar tube 12 combination from being tilted from a vertical axis. Such tilting from a vertical axis would most likely happen when the stem 208-spring chamber assembly 212-pillar tube 12 combination along with the cap 214—the top of which encircles the stem 208—is reconnected to the neck 215 of the fluid reservoir 216 after having been temporarily removed from the fluid reservoir 216 for the purpose of refilling the fluid reservoir 216 with fluid 204.

The bottom 14 of the pillar tube 12 in the preferred embodiment is closed by the attachment of disk 11. Closing the bottom 14 of the pillar tube 12 allows for an even distribution of the force to be transmitted from the bottom 14 of the pillar tube 12 to the bottom surface 217 of the fluid reservoir 216 and, hence, to the top 205 of the suction cup 202. The result is a stronger suction connection of the suction cup 202 to the surface 206 on which the pump dispenser 10 of the present invention rests because more air is dispelled from underneath the suction cup 202. Furthermore, this even distribution of force reduces the localized stress on the pillar tube 12, the localized stress on the bottom surface 217 of the fluid reservoir 216, and the localized stress on the suction cup 202. Such reduction of localized stress increases the service life of the suction cup 202.

Closing of the bottom 14 of the pillar tube 12 is accomplished by attaching a solid disk 11 to the bottom 14 of the pillar tube 12, as shown in FIG. 2. Holes for the entry of fluid into the pillar tube 12 are formed in the wall 13 in the lower portion of the pillar tube 12.

Those of ordinary skill in the art will understand that according to the construction of the disclosed invention, the fluid reservoir 216 may not be completely empty before the force normally used to dispense fluid 204 from within the fluid reservoir 216 no longer causes fluid to flow through nozzle 220. If leaving a small amount of fluid 204 within the fluid reservoir 216 is found to be objectionable, other designs for the pillar tube 12 are possible.

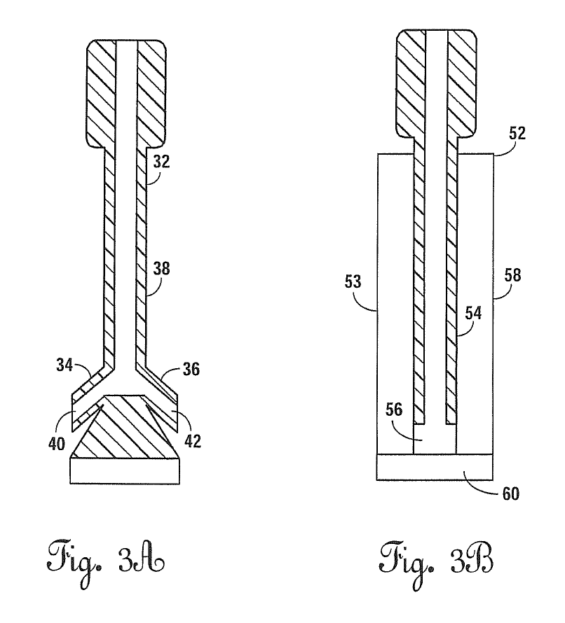

FIG. 3A and FIG. 3B illustrate two possible variations to the design of the pillar tube 12 shown in FIG. 2.

The first variation in the design of the pillar tube 32, shown in FIG. 3A, is a pillar tube 32 that includes two mini-tubes 34, 36. The mini-tubes 34, 36 emerge at an approximately 45° downward angle from the central portion 38 of the pillar tube 32. The open ends 40, 42 of the two mini-tubes 34, 36 provide for the entry of fluid 204 being sucked into the pillar tube 32 from the fluid reservoir 216.

The second variation 52 is the design of the pillar tube 12 as shown in FIG. 3B. A fluid intake tube 54 includes an opening 56 at its lower end. The solid disk 60 is attached to two or more columns 58 attached to the outside surface of the fluid intake tube 54. Each column 58 acts as a structural member for the transmission of downward force to the suction cup 202 on the bottom surface of the fluid reservoir 216.

The lower ends of the columns 58 are affixed to a bottom piece 60. The solid disk 60 rests on the bottom surface 217 of the fluid reservoir 216. The columns 58 serve as structural members that collectively serve the function of the single, larger-diameter pillar tube 12 shown in FIG. 2. The columns 58 transmit force to the top 205 of the suction cup 202 when the user of the pump dispenser 10 pushes down on the top of the stem 208 of the dispenser 10.

Portions of the pillar tube structures illustrated in FIG. 2, FIG. 3A, and FIG. 3B could be combined into a single pillar tube structure. For example, a pillar tube structure could be built with holes, projecting mini-tubes beneath these holes, and attached slender columns leading down to a solid disk with no holes. Also, it is understood that all holes shown for fluid entry in FIG. 2 and in the variations of the design of the pillar tube 12 shown in FIG. 3A and in FIG. 3B can be altered considerably with regard to their shapes, numbers, and positions.

An increase in the force transmitted to the top 205 of the suction cup 202 from a downward stroke on the dispenser stem 208 will likely lead to better evacuation of the air located beneath the suction cup 202, and consequently, a stronger suction connection to the surface 206 on which the pump dispenser 10 of the current invention is placed.

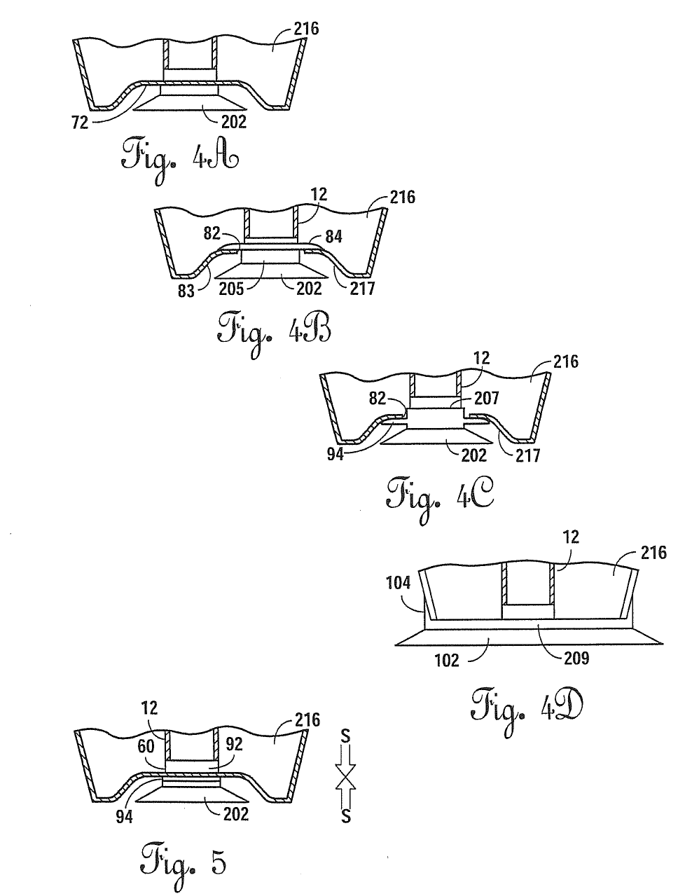

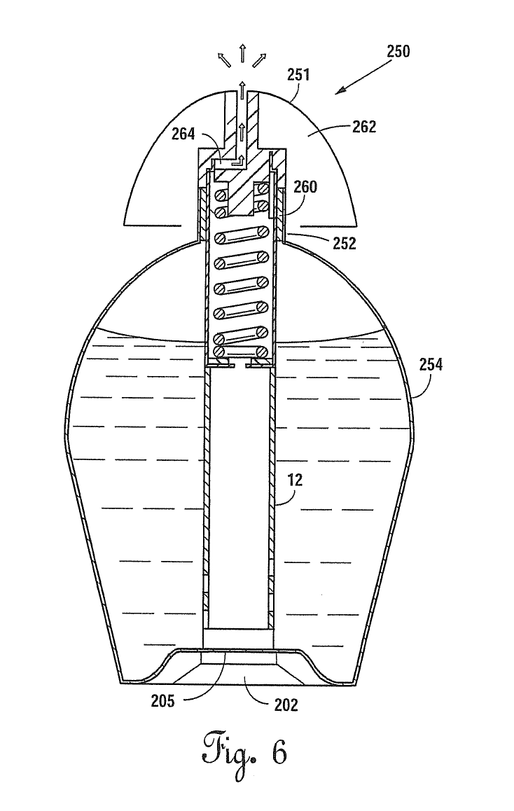

If there is a need for even stronger suction connection than that associated with the pump dispenser 10 depicted in FIG. 2, FIGS. 4A, 4B, 4C, and 4D illustrate four variations to the suction cup and the area on the bottom surface of the fluid reservoir 216 immediately above the suction cup.

Shown in FIG. 4A is the first alternate embodiment for the construction of the bottom surface of the fluid reservoir 216. In this embodiment, a section of flexible material 72, having greater flexibility than the side walls of the fluid reservoir 216, forms the bottom surface of the fluid reservoir 216.

Shown in FIG. 4B is a second alternate embodiment for the construction of the bottom surface of the fluid reservoir 216. Herein, a hole 82 is formed through the bottom surface 83 of the fluid reservoir 216. The hole 82 is directly above the suction cup 202. The hole 82 is covered by a flexible, fluid-impermeable membrane 84 that is firmly affixed to either of the interior or the exterior of the bottom surface 217 of the fluid reservoir 216. The top 205 of the suction cup 202 is attached to the flexible, fluid-impermeable membrane 84. The height of the suction cup 202 may be increased so that its upper end penetrates further into the volume of the fluid reservoir 216, although the flexible, fluid-impermeable membrane 84 will, in that case, still lie between the suction cup 202 and the bottom of the pillar tube 12.

In FIG. 4A, the bottom 14 of the pillar tube 12 rests on the flexible bottom surface 72 of the fluid reservoir 216. In FIG. 4B, the bottom of the pillar tube 12 rests on the flexible membrane 84. In both of these embodiments, the bottom surface of the fluid reservoir 216 will flex more than in the embodiment shown in FIG. 2. This greater flexing of the flexible bottom surface of the fluid reservoir 216 will enable applying more force to the top 205 of the suction cup 202 as a result of a downward stroke of the dispenser stem 208 than is applied by the bottom surface 217 of the fluid reservoir 216 described with FIG. 2.

The third alternate embodiment for the construction of the bottom surface of the fluid dispenser 216, shown in FIG. 4C, also involves placement of a hole 82 in the region of the bottom surface of the fluid reservoir 216 that is above the suction cup 202. In the embodiment shown in FIG. 4C, the top of the suction cup 202 has a greater height than that of the suction cup shown in FIG. 2. The upper end 207 of the suction cup 202 penetrates into the fluid reservoir 216. A washer-shaped, flexible, fluid-impermeable membrane 94 is tightly attached to the side of the suction cup 202 to seal the hole formed in the bottom surface of the fluid reservoir 216. The outer edge of the washer shaped, flexible, fluid-impermeable membrane 94 is tightly affixed to either the interior or the exterior of the bottom surface 217 of the fluid reservoir 216 which surrounds the hole 82.

The fourth alternate embodiment shown in FIG. 4D involves the removal of the entire bottom surface 217 of the fluid reservoir 216. The bottom surface of the fluid reservoir 216 is replaced with a large diameter suction cup 102. The upper edge of the large diameter suction cup 102 has an upward extension 104. The upward extension 104 wraps around, and is tightly attached to, the lower region of the outside side surface of the fluid reservoir 216.

In both of the embodiments shown in FIG. 4C and in FIG. 4D, the bottom 14 of the pillar tube 12 directly rests on the top 207 and 209 of the suction cup 202 and 102, respectively, before use of the dispenser 10. The top of the suction cup 205 and 102 will be likely to receive significantly more pressure when the pillar tube 12 pushes directly against it.

In the embodiments described in FIGS. 4A-4D, it is important that the length of the stem 208 situated above the cap 214 prior to dispensing fluid 204 has the proper height and that the flexible bottom surface of the fluid reservoir 216 has the appropriate stiffness such that the flexibility of the bottom surface of the fluid dispenser enables the proper amount of deformation to achieve a suction connection upon each downward stroke of the stem 208.

Another variation to the preferred embodiment 10 of the disclosed invention applied to pump dispensers is fabricating the solid disk 11 from a heavy material. Making the solid disk 11 from a heavy material enables the effects described in the following paragraph.

First, each downstroke of the stem 208 will exert a greater force on the top 205 of the suction cup 202 because of the added weight of the pillar tube 12. This greater force results in a stronger suction connection of the suction cup 202 to the surface 206 on which the pump dispenser 10 rests, since the force transmitted from the user to the top 205 of the suction cup 202 will be combined with the force associated with the added weight of the pillar tube 12. Second, making the solid disk 11 from a heavy material will lower the center of gravity of the pump dispenser 10 along with increasing the mass of the pump dispenser. The effect of this modification will be to reduce the chance of a downstroke on the stem 208 causing the pump dispenser to tip over or to move along the surface on which the pump dispenser rests.

Yet another variation to the preferred embodiment 10 of the disclosed invention applied to pump dispensers is illustrated in FIG. 5. This variation may be applied separately or in combination to what is illustrated in FIG. 3 and in FIG. 4. The solid disk 11, as shown in FIG. 2, is a first piece of ferromagnetic material 92 either directly attached to the pillar tube 12 or to the solid piece 60 on the end of the pillar tube 12. A second piece of ferromagnetic material 94 is placed on the top 205 of the suction cup 202. As shown in FIG. 5 the polarities of the pieces of ferromagnetic material 92, 94 are oriented to repel one another. Because ferromagnetic materials are relatively heavy, the combined weight of the two pieces of ferromagnetic materials 92, 94 will add to the force transmitted by the user to the top 205 of the suction cup 202 when the user pushes downwardly on the stem 208. The weight of both pieces of ferromagnetic material 92, 94 will also reduce the chance of the dispenser turning over or moving along the surface on which it rests when the user pushes downwardly on the stem 208.

Furthermore, the two pieces of ferromagnetic material 92, 94 will add to the force exerted on the top 205 of the suction cup 202 when the user pushes downwardly on the stem 208. Specifically, the two pieces of ferromagnetic material 92, 94 at the lower end of the pillar tube 12 will magnetically repel each other near the top 205 of the suction cup 202.

Those of ordinary skill in the art will understand that there are many additional ways to link the stem at the top of a dispenser with the suction cup at the bottom of the dispenser so that the force exerted by the user on the top of the dispenser not only dispenses fluid but also re-establishes or reinforces the suction connection between the suction cup on the bottom of the dispenser and the surface on which it rests.

The disclosed invention can also be applied to aerosol dispensers, such as those used as air fresheners. This is because household aerosol dispensers include the basic structural features found in prior art pump dispensers such as the one shown in FIG. 1.

Those of ordinary skill in the art will understand that while the structure of aerosol dispensers is similar to that of the prior art pump dispenser shown in FIG. 1, the means by which fluid is expelled from an aerosol dispenser is very different from the way fluid is expelled from a pump dispenser. With an aerosol dispenser, a downward stroke on the stem moves the stem such that an open path is created between the pressurized fluid reservoir and the outside air. Fluid is both pushed from the pressurized fluid reservoir into the fluid intake tube and forced outwardly through the nozzle (i.e., sprayed out) by the gas pressure within the pressurized fluid reservoir. The change in the volume of the spring chamber assembly able to contain fluid plays a relatively insignificant role in expelling the fluid from within the pressurized fluid reservoir. No ball check valves, as shown in FIG. 1, are used with an aerosol dispenser.

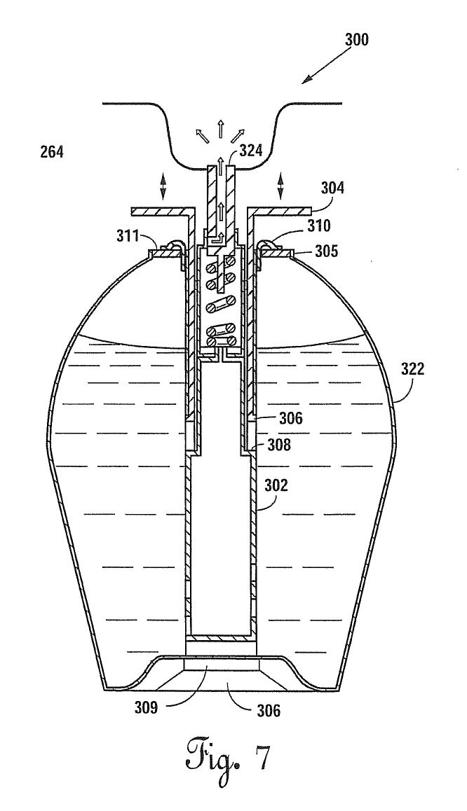

FIG. 6 shows the disclosed invention applied to an aerosol dispenser 250. Consistent with the structural similarities associated with the application of the disclosed invention to pump dispensers as shown in FIG. 2, the path for the transmission of force in an aerosol dispenser from the user to the top 205 of the suction cup 202 is the same as the path of transmission of downward force described with respect to the pump dispenser 10 shown in FIG. 2.

Although the word “spray” is used above, it is understood that the fluid dispelled from an aerosol type dispenser could be dispensed as foam as well as in the form of a spray.

As may be seen in FIG. 6, the stem-spring chamber assembly 262 is detached from the top surface 252 of the fluid reservoir 254.

A substantially cylindrical ring 260 is surrounding and affixed to the stem-spring chamber assembly 262 and assures that the entire stem-spring chamber assembly 262-pillar tube 12 combination will always be oriented in a substantially vertical direction within the fluid reservoir 254.

When the hand of the user exerts a downward force on the top 251 of the aerosol dispenser 250, a path 264 for the passage of fluid from within the pressurized fluid reservoir 254 is opened.

The downward force from the hand of the user is transmitted by the pillar tube 12 to the bottom surface of the fluid reservoir 254 as in the pump dispenser 10 depicted in FIG. 2. The force on the bottom surface of the fluid reservoir 254 is transmitted to the top 205 of the suction cup 202 as in the preferred embodiment.

As will be described below, the disclosed invention can also be applied to misting type dispensers. The key difference between a misting type dispenser and an aerosol dispenser is that a misting type dispenser does not retain a pressurized propellant gas. Rather, the gas pressure utilized to dispense fluid from a misting type dispenser is mechanically generated by a slide pump assembly each time the misting type dispenser is used.

FIG. 7 illustrates the application of the disclosed invention to a misting type dispenser 300. As can be seen from the specific shape of the pillar tube 302 within the fluid reservoir 322, the disclosed invention will provide increased stability for the dispenser 300 during both the actual misting of the fluid contained within the fluid reservoir 322 of a misting type dispenser and during the mechanical generation of the pressure needed to propel the mist from the misting type dispenser 300 by the slide pump assembly 304. During the actual misting of the fluid, the bottom of the stem-spring chamber assembly 324 contacts the top of the pillar tube 302. This contact transmits a downward force from the user to the pillar tube 302 and then onto the top 309 of the suction cup 306 positioned on the bottom of the misting type dispenser 300.

When mechanical force is used to generate the pressure needed to dispense the mist from the misting type dispenser 300, part of this force is transmitted to the pillar tube 302, and then onto the top 305 of the suction cup 306, by contact between the bottom 306 of the slide pump assembly 304 and ledges 308 formed on the side of the pillar tube 302.

Further enabling the utilization of the disclosed invention with a misting type dispenser 300 is the use of a washer shaped, flexible rubber piece 310 whose inner edge surrounds and is affixed to the slide pump assembly 304 and whose outer edge is affixed to a substantially circular ring that in turn is firmly but removably attached to a notch 305 at the top of the fluid reservoir 322.

Application of the disclosed invention to misting type dispensers may enable the manufacture of an air freshener dispenser that is both very convenient to use and safe. The fluid reservoir of such a misting type dispenser could be filled with a fragrant, non-toxic oil. Then, consistent with the dispenser shown in FIG. 7, a user could press the slide pump assembly 304 two or three times with one hand and then, with the same hand, depress the top of the stem and actually spray out the fragrant, non-toxic oil. The application of the disclosed invention will keep the air freshener stationary throughout the use of the plunger and the process of dispensing the fragrant, non-toxic oil.

The disclosed invention has been described as the direct transmission of fluid-dispensing force applied to a dispenser to the top of a suction cup located on the bottom of the dispenser. It is this application of a fluid-dispensing force that re-establishes or reinforces the suction on the bottom of the dispenser as soon as the dispenser has begun to be used, thereby significantly increasing dispenser stability. The disclosed invention may be more broadly generalized to include any linking of the dispensing of fluid with an increased stability of the dispenser. For example, the embodiments presented herein could be modified as disclosed in the following paragraphs.

The top of the spring within the spring chamber assembly could be pulled down by a means other than by a simple downward motion of the stem that is attached to the top of the spring. For example, the top of the spring could be pulled down by the movement of an outside lever. From a more general perspective, while the disclosed invention has been described as involving a direct transmission of force from the user to the top of the suction cup of a given dispenser, the use of the word “direct” is meant to indicate a mechanical pathway for transmission of force that is more direct than the usual force transmission along the sides of the fluid reservoir of a prior art dispenser. Accordingly, the disclosed invention should not be taken to preclude the use of simple means for the amplification of mechanical force in the transmission of force from the user to the top of the suction cup.

The initial force imparted by the user to dispense fluid could be in any direction and the exact path of force transmission from the user to the top of the suction cup could vary among different types of dispensers.

Furthermore, the disclosed invention could be applied to those dispensers which do not include using a spring, if a spring is not involved in dispensing fluid.

The stem-spring chamber assembly and the pillar tube could be separated from each other, with the resulting lower and upper portions of each of the stem-spring chamber assembly and pillar tube reconnected to each other with a spring. Such reconnection of the stem-spring chamber assembly and pillar tube with a spring could be helpful if the insertion of additional springs into the stem-spring chamber assembly-pillar tube combination might reduce wear on the main spring within the stem-spring chamber assembly.

The pillar tube could have either a narrower or wider diameter than the diameter of the top of the suction cup, provided that sufficient air can still be forced out from underneath the suction cup at the beginning of the dispensing of fluid. Changing the dimensions of the pillar tube may be necessary because the dimensions of the pillar tube may be restricted for reasons of cost or strength or for achievement of an adequate rate of fluid flow from the fluid reservoir. It is understood that a pillar tube with a relatively narrow diameter would have to be able to withstand the compression force associated with being repeatedly pressed toward a relatively immovable surface at its lower end.

The presence of the pillar tube within the fluid reservoir does not preclude the simultaneous presence of a standard fluid intake tube placed in its standard location, and therefore, located within the pillar tube. Fluid could flow from within the fluid reservoir into the pillar tube through its holes, be drawn into the opening of the standard fluid intake tube, and then drawn into the stem-spring chamber assembly.

In both pump and aerosol dispensers, the stem-spring chamber assembly does not have to be detached from the cap or the top surface of the fluid reservoir if the cap or the top surface of the fluid dispenser have enough flexibility when the user pushes on the top of the stem to transmit sufficient force to the top surface of the suction cup.

In both pump and aerosol dispensers, the substantially cylindrical ring does not have to be directly affixed to the outer surface of the stem-spring chamber assembly. Specifically, there could be a gap between the substantially cylindrical ring and the stem-spring chamber assembly, with the substantially cylindrical ring possibly held in place around the stem-spring chamber assembly by spokes or by an extension arising from the outer surface of the stem-spring chamber assembly. The substantially cylindrical ring does not have to have a perfectly circular shaped cross section. The substantially cylindrical ring could even be attached to a portion of the pillar tube instead of or in addition to the stem-spring chamber assembly. The important feature of the substantially cylindrical ring is that it has some presence at the opening of the fluid reservoir, and that its presence keeps the stem-spring chamber assembly-pillar tube combination in a substantially vertical orientation.

A substantially cylindrical ring need not be used. Instead, the stem-spring chamber assembly and the opening at the top of the fluid reservoir could each inherently have dimensions such that the stem-spring chamber assembly-pillar tube combination can only be oriented vertically whenever the stem-spring chamber assembly-pillar tube combination is returned to the fluid reservoir after a temporary removal. Alternatively, a relatively shallow depression could be made in the bottom surface of the fluid reservoir so that the lower end of the pillar tube fits into the shallow depression. Such a structure would force the stem-spring chamber assembly-pillar tube combination to be oriented in a substantially vertical direction. If a shallow depression is formed in the bottom surface of the fluid reservoir, the user guides the pillar tube into the corresponding depression every time the stem-spring chamber assembly-pillar tube combination is removed and returned to the dispenser.

Yet another alternative to a substantially cylindrical ring includes affixing the lower end of the pillar tube to the bottom surface of the fluid reservoir or to the top of the suction cup in cases where the lower end of the pillar tube directly rests on the suction cup prior to use of the dispenser, and the stem-spring chamber assembly-pillar tube combination could be designed to be separable to make it possible to remove some upper portion of the stem-spring chamber assembly-pillar tube combination to be able to refill the fluid reservoir. Affixing the lower end of the pillar tube to the bottom surface of the fluid reservoir would only be acceptable if the portions of the stem-spring chamber assembly-pillar tube combination were rejoined after refills such that no air leaks into the stem-spring chamber assembly-pillar tube combination as fluid flows upwards in the stem-spring chamber assembly-pillar tube combination.

The suction cup at the bottom surface of the fluid reservoir could be made to be removable from the bottom surface if desired. Also, the suction cup could be made to enable a tight interfitment into an upwardly projecting pocket at the bottom surface of the fluid reservoirs. Such tight interfitment would enable detaching the suction cup from the bottom surface of the fluid reservoir if needed.

The suction cup could be replaced with a Velcro® attachment system in cases where the bottom surface of the fluid reservoir is made to be flat. A dispenser including the disclosed invention would then be rested on one part of the Velcro® attachment system to which the other part of the Velcro® attachment system would stick. Force transmitted when the user dispenses fluid would assure that the Velcro® attachment system maintains a connection that provides stability to the dispenser.

The transmission of force could be substantially horizontal as opposed to being substantially vertical. For example, a dispenser including the disclosed invention could be attached to a wall with a suction connection as opposed to being attached to a flat surface such as a bathroom sink or a kitchen counter with a suction connection. For such substantially horizontal orientation, the fluid reservoir would have to be flattened to overcome the large torque that would occur on any object that has a substantially horizontal orientation that has one end attached to a wall with a suction connection.

A pump dispenser including the disclosed invention could also be a foam dispenser. Such a foam dispensing dispenser would include a means of mixing air into the fluid to be dispensed and then homogenizing the resulting foam.

A dispenser including the disclosed invention could dispense gas or solids in addition to dispensing liquids, semi-solids, or liquids mixed with solids in a propelling gas. The dispenser could dispense a combination of any flowable fluids.

The application of the disclosed invention to pump dispensers would also enable dispensing small solids, such as ice cream sprinkles, which would be drawn into the nozzle within a stream of air.

The disclosed invention applied to aerosol dispensers would also be appropriate for dispensing pressurized gas in cases where no separate propellant is needed.

### Advantages

Those of ordinary skill in the art will understand that the direct transmission of the force applied to dispense the fluid within the fluid reservoir to the top of the suction cup that is affixed to the bottom of the dispenser significantly reduces the probability that the dispenser will tip over or move across the surface on which it rests. A pump dispenser including the disclosed invention will maintain its same location from use-to-use. Maintaining the same location from use-to-use will decrease the probability of the dispensed fluid getting underneath the suction cup of the dispenser and enable its repetitive use in low light conditions by users with difficulty seeing.

The disclosed invention prevents the inconvenience of a plastic pump dispenser falling into a bathroom or kitchen sink or onto a shower floor. Further, the disclosed invention can prevent the destruction of a breakable dispenser and the possible danger of being injured when a glass, ceramic or porcelain dispenser shatters after falling onto a floor or other hard surface.

It has also been found that the present invention enables those individuals with reduced motor skills to avoid tipping a fluid dispenser over or moving the dispenser to where it is not easily used. Such individuals may include children reaching up to activate the fluid dispenser, elderly individuals with arthritis, disabled individuals or those individuals having nerve or muscular diseases which limit range of movement.

Those health care practitioners who clean their hands between examining each of their patients will also benefit from the disclosed invention by not losing the time associated with replacing a dispenser to where it is regularly located. The general level of hygiene for health care practitioners will also be increased as the need to re-wash one's hands after retrieving a dispenser from the bottom of a sink or picking up a dropped dispenser from the floor will be substantially reduced.

The benefits of the present invention would also be appreciated by users of boats or recreational vehicles in which surfaces do not remain stable. Through use of the disclosed invention, users will experience better hygiene by being able to use a dispenser which remains available by not being moved from its resting place by the motion of the boat or recreational vehicle.

The design of the fluid reservoir of prior art fluid dispensers would not have to be substantially modified to accommodate the disclosed invention.

Those changes that would have to be made to a dispenser to allow for use of the disclosed invention would be relatively easy to implement. The pillar tube and substantially cylindrical ring could likely be made from inexpensive recyclable plastic. The reduction of the tendency of a plastic dispenser to fall down during use would allow manufacturers to make fluid reservoirs with less robust plastic than is normally used to add weight to a dispenser for stability. The opportunity to reduce the amount of plastic used to manufacture a particular line of pump dispensers saves money for manufacturers and benefits the environment as well by reducing the amount of energy used for the production of plastic dispensers including the disclosed invention.

If a downward stroke applied to a dispenser causes the dispenser to produce a light or a sound such as music or a verbal message when dispensing fluid, the dispenser will need a pressure or movement sensitive element to activate the lights, sound or verbal messages. By use of the disclosed invention, the force transmitted to the suction cup when the user pushes on the top of the dispenser to dispense fluid could also be used to activate pressure or movement sensitive elements attached to the dispenser. Furthermore, the possibility of a pressure or movement sensitive element malfunctioning from exposure to fluid will be reduced.

If the fluid reservoir portion of a dispenser and the fluid that it contains are transparent or translucent, then the pillar tube will always be visible to the user of a dispenser including the disclosed invention. In such case, the pillar tube could be made to include some decorative appeal. Such decorative appeal could include bubbles that emerge out of the holes in the pillar tube.

While the present invention has been disclosed according to its preferred and alternate embodiments, those of ordinary skill in the art will understand that additional embodiments have been enabled by the foregoing disclosure. Such additional embodiments shall fall within the scope and meaning of the appended claims.

I claim:

1. A pump dispenser for dispensing small amounts of fluid in response to manual force from the hand of a user, said pump dispenser including a fluid reservoir with an opening at the top thereof, a spring chamber assembly including check valves at the top and bottom thereof to enable the passage of fluid therethrough, said spring chamber assembly being located in the opening at the top of the fluid reservoir, said pump dispenser further comprising:
a movable system for receiving the manual force from the hand of the user;
said movable plunger constructed and arranged to cause the spring within the spring chamber assembly to compress in response to the manual force from the hand of the user;
a pillar tube extending from the bottom of the spring chamber assembly through the fluid reservoir to the bottom of the fluid reservoir;
said pillar tube constructed and arranged to transmit the manual force from the spring chamber assembly to the bottom of the fluid reservoir;
said pillar tube enabling the passage of fluid from within the fluid reservoir to the interior of the spring chamber assembly;
a force sensitive attachment device located on the exterior of the bottom of the fluid reservoir;
whereby the manual force from the hand of the user will cause a small amount of fluid to exit the spring chamber assembly and to be dispensed from the pump dispenser and will also cause force to be applied to said force sensitive attachment device on the bottom of the fluid reservoir by the transmission of force through said pillar tube thereby increasing the stability of the pump dispenser with respect to the surface on which it rests.

2. The pump dispenser as defined in claim 1 wherein said pillar tube includes a plurality of holes formed through the wall thereof.

3. The pump dispenser as defined in claim 2 wherein said pillar tube further includes a downwardly angled tube extending from at least one hole formed in the wall of said pillar tube.

4. The pump dispenser as defined in claim 1 wherein said pillar tube includes an opening at the bottom thereof and a plurality of columns formed along its outer wall.

5. The pump dispenser as defined in claim 1 wherein the transmission of force from the bottom of said pillar tube to the bottom of said fluid reservoir uses the repulsive force between two magnetic pieces of like polarity.

6. The pump dispenser as defined in claim 1 wherein said force sensitive attachment device is located on a flexible portion of the bottom of the fluid reservoir.

7. The pump dispenser as defined in claim 1 wherein said force sensitive attachment device is mounted within a hole formed in the bottom of the fluid reservoir.

8. The pump dispenser as defined in claim 1 wherein said force sensitive attachment device forms the bottom of the fluid reservoir.

9. The pump dispenser as defined in claim 1 wherein said force sensitive attachment device is a suction cup.

10. The pump dispenser as defined in claim 1 wherein said force sensitive attachment device is a Velcro® pad.

11. An aerosol dispenser for dispensing small droplets of fluid in response to a manual force from the hand of a user, said aerosol dispenser including a pressurized fluid reservoir, a stem-spring chamber assembly for metering the flow of droplets located in the top of the pressurized fluid reservoir, said aerosol dispenser further comprising:
a surface for receiving the manual force from the hand of the user and transmitting said manual force to the stem-spring chamber assembly;
a pillar tube extending from the bottom of said stem-spring chamber assembly through the pressurized fluid reservoir to the bottom of the pressurized fluid reservoir;
said pillar tube constructed and arranged to transmit the manual force from the bottom of the stem-spring chamber assembly to the bottom of the pressurized fluid reservoir;
said pillar tube enabling the passage of fluid from within the pressurized fluid reservoir to the interior of the stem-spring chamber assembly;
a force sensitive attachment device located on the exterior of the bottom of the pressurized fluid reservoir;
whereby the manual force from the hand of the user will cause small droplets of fluid to exit the stem-spring chamber assembly and the manual force from the hand of the user will apply force to said force sensitive attachment device through said pillar tube thereby increasing the stability of the aerosol dispenser with respect to the surface on which it rests.

12. The aerosol dispenser as defined in claim 11 wherein said pillar tube includes a plurality of holes formed in the wall of said pillar tube.

13. The aerosol dispenser as defined in claim 12 wherein said pillar tube further includes at least one downwardly angled tube extending from a hole in the wall of said pillar tube.

14. The aerosol dispenser as defined in claim 11 wherein said pillar tube includes an opening at the bottom thereof and a plurality of columns formed along its outer wall.

15. The aerosol dispenser as defined in claim 11 wherein the transmission of force from the bottom of said pillar tube to the bottom of the pressurized fluid reservoir utilizes the repulsive force between like poles of magnetic pieces.

16. The aerosol dispenser as defined in claim 11 wherein said force sensitive attachment device is located on a flexible portion of the bottom of the pressurized fluid reservoir.

17. The aerosol dispenser as defined in claim 11 wherein said force sensitive attachment device is mounted within a hole formed in the bottom of the pressurized fluid reservoir.

18. The aerosol dispenser as defined in claim 11 wherein said force sensitive attachment forms the bottom of the pressurized fluid reservoir.

19. The aerosol dispenser as defined in claim 11 wherein said force sensitive attachment device is a suction cup.

20. The aerosol dispenser as defined in claim 11 wherein said force sensitive attachment device is a Velcro® pad.

21. A misting type dispenser for dispensing a fluid mist in response to manual force from the hand of a user, said misting type dispenser including a fluid reservoir including an opening at the top thereof, a stem-spring chamber assembly for metering the flow of the fluid mist located in the top of the fluid chamber, and a sliding pump assembly, said misting type dispenser comprising:
a surface for receiving the manual force from the hand of the user and transmitting the manual force to the stem-spring chamber assembly to dispense fluid;
a pillar tube extending from the bottom of the stem-spring chamber assembly through the fluid reservoir to the bottom the fluid reservoir;
said pillar tube constructed and arranged to transmit the manual force from the bottom of the stem-spring chamber assembly to the bottom of the fluid reservoir;
said pillar tube constructed and arranged to transmit the manual force on the sliding pump assembly to the bottom of the fluid reservoir;
said pillar tube enabling the passage of fluid from within the fluid reservoir to the interior of the stem-spring chamber assembly;
a force sensitive attachment device located on the exterior of the bottom of the fluid reservoir;
whereby the manual force from the hand of the user on the sliding pump assembly will generate the pressure needed to expel a fluid mist and apply force to said force sensitive attachment device through said pillar tube and the manual force from the hand of the user on the stem-spring chamber assembly to dispense fluid will apply force to said force sensitive attachment device through said pillar tube thereby resulting in increased stability of the misting type dispenser with respect to the surface on which it rests.

22. The misting type dispenser as defined in claim 21 wherein said pillar tube includes a plurality of holes formed in the wall of said pillar tube.

23. The misting type dispenser as defined in claim 22 wherein said pillar tube further includes at least one downwardly angled tube extending from a hole in the wall of said pillar tube.

24. The misting type dispenser as defined in claim 21 wherein said pillar tube includes an opening at the bottom thereof and a plurality of columns formed along its outer wall.

25. The misting type dispenser as defined in claim 21 wherein the transmission of force from the bottom of said pillar tube to the bottom of the fluid reservoir utilizes the repulsive force between like poles of magnetic pieces.

26. The misting type dispenser as defined in claim 21 wherein said force sensitive attachment device is located on a flexible portion of the bottom of the fluid reservoir.

27. The misting type dispenser as defined in claim 21 wherein said force sensitive attachment device is mounted within a hole from on the bottom of the fluid reservoir.

28. The misting type dispenser as defined in claim 21 wherein said force sensitive attachment device forms the bottom of the fluid reservoir.

29. The misting type dispenser as defined in claim 21 wherein said force sensitive attachment device is a suction cup.

30. The misting type dispenser as defined in claim 21 wherein said force sensitive attachment device is a Velcro® pad.

31. A method for stabilizing a dispenser used for dispensing a small amount of fluid in response to the manual force from the hand of a user wherein the dispenser includes a fluid reservoir, an opening at the top of the fluid reservoir, a stem-spring chamber assembly positioned within the opening at the top of the fluid dispenser for metering the flow of fluid dispensed from the fluid reservoir in response to the manual force from the hand of the user, and a pressure sensitive attachment device on the exterior of the bottom of the fluid reservoir, said method comprising the step of:
positioning a pillar tube to extend between the bottom of the stem-spring chamber assembly and the bottom of the fluid reservoir;
whereby the manual force from the hand of the user will cause a small amount of fluid to be dispensed from the fluid reservoir through the stem-spring chamber assembly and the manual force from the hand of the user will apply pressure to the pressure sensitive attachment device on the exterior of the bottom of the fluid reservoir by transmitting force from the bottom of the stem-spring chamber assembly to the bottom of the fluid reservoir and thence to the pressure sensitive attachment device on the exterior of the bottom of the fluid reservoir with said pillar tube.

32. The method as defined in claim 31 further including the step of detaching the stem-spring chamber assembly from the opening at the top of the fluid dispenser.
